(19) United States
(12) Patent Application Publication
(10) Pub. No.: US 2015/0187490 A1
(43) Pub. Date: Jul. 2, 2015

(54) CURRENT TRANSFORMER HAVING A SHORT-CIRCUIT DEVICE

(71) Applicant: PHOENIX CONTACT GMBH & CO. KG, Blomberg (DE)

(72) Inventor: Dat-Minh Trinh, Barntrup (DE)

(73) Assignee: Phoenix Contact GMBH & Co. KG a corporation

(21) Appl. No.: 14/420,655

(22) PCT Filed: Aug. 7, 2013
(86) PCT No.: PCT/EP2013/066579

§ 371 Date: Feb. 9, 2015

(30) Foreign Application Priority Data
Aug. 8, 2012 (DE) 10 2012 107 279.5

(51) Int. Cl. H01F 27/40; H01F 27/29; H01F 27/02

(52) U.S. Cl. CPC H01F 27/40; H01F 27/02; H01F 27/29

(57) ABSTRACT

The invention relates to a current transformer 1, having connection contacts 2 for contacting a secondary winding and having a short-circuit device 3′, 3″ for shorting the connection contacts 2, wherein the short-circuit device 3′, 3″ has a mechanically movable conductor 4 that can be brought into a circuit between the connection contacts 2 of the secondary winding. Here, the short-circuit device 3′, 3″ is integrated in a housing 14 surrounding the current transformer 1 and the movable conductor 4 can be moved by a rotary or pivot motion into the circuit between the connection contacts 2, such that the circuit of the secondary coil is shorted.

### CROSS-REFERENCE TO RELATED APPLICATIONS

This application is a U.S. 371 National Stage Application of International Application No. PCT/EP2013/066579 filed Aug. 7, 2013, published as W02014/023783 A1, which claims priority from German Patent Application No. 10 2012 107 279.5, filed Aug. 8, 2012, published as DE 10 2012 107279A1, which are incorporated herein by reference in entirety.

The invention relates to a current transformer having a short-circuit device with which the secondary winding of the current transformer can be shorted.

Current transformers are usually used to measure alternating currents and operate in accordance with the principle of the Rogowski coil. Here, an alternating current flowing in a primary coil or in a primary conductor induces an electric current in a secondary coil that is generally arranged annularly. The primary coil often has only very few windings or only a single winding compared to the secondary coil due to the fact that the primary conductor is passed through the secondary coil. In this case reference is made to a window-type transformer or straight-through transformer. The magnitude of the current induced in the secondary winding is dependent on the number of secondary windings and is substantially proportional to the inducing primary current. It is therefore very suitable as a measurand or control variable.

In contrast to the Rogowski coil, a current transformer has a usually toroidal ferromagnetic core which, by the bundling of the magnetic field, ensures a high efficacy and a high accuracy in terms of the proportionality between primary and secondary current. On account of the high efficacy, a current transformer generates secondary currents high enough to directly control or regulate further circuit components without further amplification.

However, this causes the disadvantage that a secondary circuit of a current transformer must never be operated open, since otherwise the very high (“infinite”) resistance between the open secondary terminals leads to very high voltages therebetween. These would not only pose a risk to humans, but would also lead to voltage flashovers and breakdowns, which can destroy the current transformer.

One advantage of current transformers is the galvanic isolation of primary current and secondary current. The secondary circuit is therefore independent of the potential of the primary circuit. Fundamentally potential-free modifications of the secondary circuit are thus possible without having to disconnect a primary circuit, which is not potential free.

There is thus a motivation, for example in power supply arrangements, to be able to make modifications to a circuit arrangement of the secondary circuit with a current transformer in operation on the primary side, without the current transformer being destroyed by an interim interruption of the secondary circuit.

This objective can be achieved by temporarily shorting the secondary circuit of the current transformer prior to the separation of connection conductors.

Solutions with which this objective can be achieved in principle are known from the prior art.

US 2009/0186504 A1 describes a connection system for a current transformer in which, besides the electrical contacts, a plug contact additionally has a pin, the removal of which causes a shorting of the secondary contacts.

Further, DE 16 13 706 B described a short-circuit arrangement for the secondary circuit of a current transformer, in which the removal of a pin associated with a plug contact also leads to the shorting of the short-circuit arrangement.

In order to enable a closing or opening of the short-circuit arrangement, however, both solutions require specially formed plug contacts on the circuit side.

The object of the invention is to specify a current transformer having a simple and practical short-circuit device that allows a direct connection of conductors to the current transformer.

The object is achieved in accordance with the invention by the features of the subject matter of claim 1. Advantageous embodiments of the invention are specified in the dependent claims.

In accordance with the invention a current transformer is therefore provided that comprises connection contacts for contacting a secondary winding, the current transformer having a short-circuit device for shorting the connection contacts, wherein the short-circuit device has a mechanically movable conductor that can be brought into a circuit between the connection contacts of the secondary winding, characterised in that the short-circuit device is integrated in a housing surrounding the current transformer and the movable conductor can be moved by means of a rotary or pivot motion into the current circuit between the connection contacts, such that the circuit of the secondary winding is shorted.

The advantage of this solution lies in the fact that the connection contacts do not need to have any special requirements of a manufacturing of the conductor to be connected. The connection contacts can be formed such that stripped cables can be contacted directly.

The connection contacts, which for example are to be manipulated via a housing opening, are preferably formed as screw or clamp contacts, spring connections or push-in connections.

A further advantage of the solution lies in the fact that the current transformer and short-circuit device are integrated in a housing. There is no need for any external aids, such as an external wire bridge, special protective caps or an unlocking pin. All the components of the short-circuit device can be integrated in the housing.

The short-circuit device is integrated in the current transformer housing, but can be manipulated from outside.

The movable conductor of the short-circuit device is advantageously moved by a rotary or pivot motion into the circuit between the connection contacts. The rotary or pivot motion offers the advantage that necessary forces for opening or closing the short-circuit device can be reliably introduced via a lever arm.

Such a lever arm can be integrated into the housing or applied externally by a commercially available tool, such as a screwdriver.

In order to cause the rotary or pivot motion from outside, the housing advantageously has a corresponding housing opening for this purpose.

The movable conductor of the short-circuit device is advantageously formed as a short-circuit piece in the form of a rigid metal conductor.

For reliable electrical contact, it is necessary for at least one of the contacts to be sprung at least to a certain extent, whereas the counter-contact can be rigid.

In order to attain an economical embodiment it is advantageous to form the connection contacts in such a way that they have a leg at which they can be contacted at a contact point or short-circuit contact by the movable conductor.

Due to the geometry and flexural rigidity of the connection contact, such a leg has the necessary spring characteristic for reliable contact at short-circuit contacts arranged in the middle or end region, such that the movable conductor can be formed economically as a short-circuit piece in the form of a rigid metal conductor.

Here, it is expedient, but not necessary, for the connection contacts themselves to each have a short-circuit contact, and the connection contacts can also each be electrically conductively connected with a short-circuit contact as an independent element in each case.

In a first advantageous embodiment of the invention, the axis of rotation or swivel axis runs in an axis through the short-circuit contacts or parallel thereto.

Such an embodiment allows an economical embodiment, since one or more levers pointing radially away from this axis can contact the short-circuit contacts with appropriate dimensioning.

With a symmetrical arrangement in which two short-circuit contacts have equal distances from the axis of rotation, both short-circuit contacts can be contacted at the same time by one short-circuit piece moved about the axis of rotation at this distance.

The short-circuit device advantageously has an angled cross section, wherein the axis of rotation or swivel axis runs through the bend of the angle.

In such an embodiment two levers pointing radially away from the axis of rotation are formed by one structural component at the same time. Here, a leg of the angle can be formed advantageously as an actuating arm, and the other leg advantageously can comprise the short-circuit piece.

Such an embodiment allows a compact and economical embodiment that can be implemented in a confined space with few structural components.

A flush accommodation of the actuation arm in the housing surface or a recessing of the actuation arm offers the advantage of a compact design with all resultant advantages in terms of assembly dimensions, storage, transport, etc., but also in terms of robustness with respect to possible damage or safety due to the exclusion of protruding components as a source of danger.

The current transformer is advantageously formed such that the actuation arm of the short-circuit device protrudes visibly from the surface of the housing in a shorted state.

The state of the current transformer and short-circuit device thereof is thus directly apparent, which significantly reduced the risk of operating errors.

To this end, the axis of rotation or swivel axis is advantageously arranged in or beneath the wall of the housing on the end face or connection side of the current transformer.

Here, it may run more advantageously parallel to the longitudinal axis thereof.

Such an embodiment offers the advantage that the actuation arm is arranged clearly on a side of the housing on which it is clearly visible, even in the assembled state.

The actuation arm advantageously also has an eyelet, such that it can be secured by means of a wire seal in cooperation with a second eyelet, which is arranged in or on the housing the current transformer.

A closure of the short-circuit device without destroying the wire seal can thus be ruled out. This property is then particularly advantageous when the current transformer is used as a current measuring device and is to be secured against manipulation, for example a temporary disconnection.

In another advantageous embodiment of the invention the axis of rotation runs orthogonally to the direct path between the short-circuit contacts.

With such an arrangement, a short-circuit piece located between the short-circuit contacts can be removed from the circuit between the short-circuit contacts by twisting, such that this embodiment likewise can be implemented in a mechanically simple manner.

The axis of rotation advantageously can lie here centrally between the short-circuit contacts, which leads to rotary arms of equal length on either side of the axis of rotation and enables a particularly compact design.

The short-circuit piece is advantageously arranged on a rotary device. This can be designed advantageously for a rotatable mechanical mounting and may have a means for actuation of the rotation of the short-circuit piece.

The rotary device for example may thus have an axis with two distanced plates. A web of the housing running between the plates can fix the axis both in the radial and axial direction in the form of a floating bearing.

The plates are advantageously formed as round plates, and the short-circuit piece is fastened on one of these round plates at the sides thereof.

Such an arrangement offers the advantage that the short-circuit piece can be rotated in easily between the sprung short-circuit contacts, since the short-circuit contacts resting against the round plate are already tensioned by the round plate prior to the contact of the short-circuit piece and no further forces for tensioning the sprung short-circuit contact are necessary due to the flush termination of round plate and short-circuit piece.

The rotary device, the round plate and/or the short-circuit piece is/are also advantageously provided with a means for rotation. This may be a lever or a recess for receiving a tool for exerting a torque.

The surface of the housing more advantageously has an opening through which the means for rotation can be manipulated, such that for example a recess in the rotary device, the round plate and/or the short-circuit piece can be reached by an insertable tool, for example a screwdriver.

The rotary device, the round plate and/or the short-circuit piece is/are therefore expediently arranged beneath the surface of the housing on the end face of the current transformer.

In an advantageous embodiment of the fastening of the short-circuit piece on the round plate, said short-circuit piece has laterally resilient hooks, by means of which it can be latched in a guide receptacle of the round plate.

Such a latched connection can be provided economically and additionally can be easily detached, such that a short-circuit piece possibly burned at the contacts thereof can be easily exchanged.

The invention will be explained in greater detail hereinafter with reference to the accompanying drawing on the basis of preferred embodiments.

In the drawing

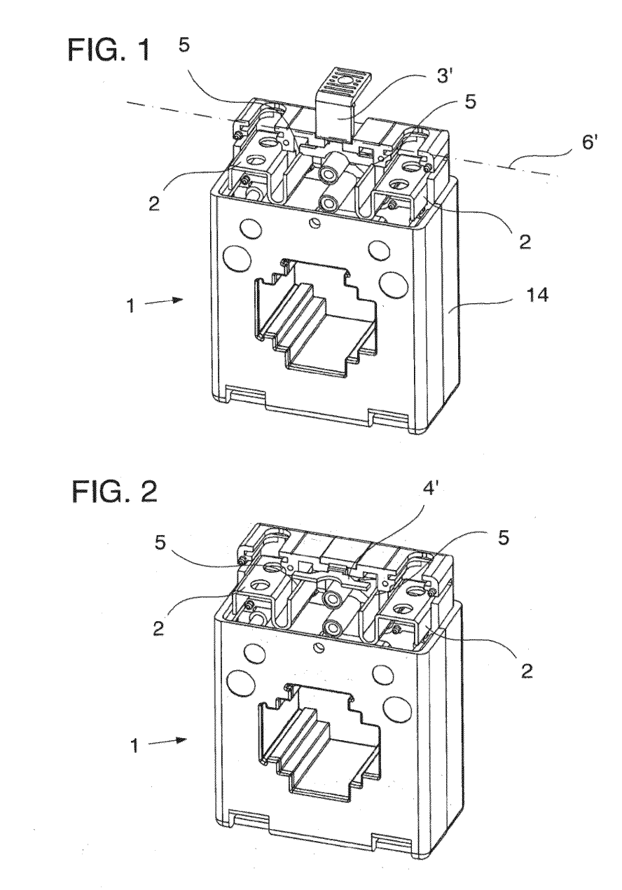

FIG. 1 shows a perspective illustration of a first embodiment of a current transformer according to the invention with shorted short-circuit device with partially open housing head,

FIG. 2 shows a perspective illustration of a first embodiment of a current transformer according to the invention with open short-circuit device with partially open housing head,

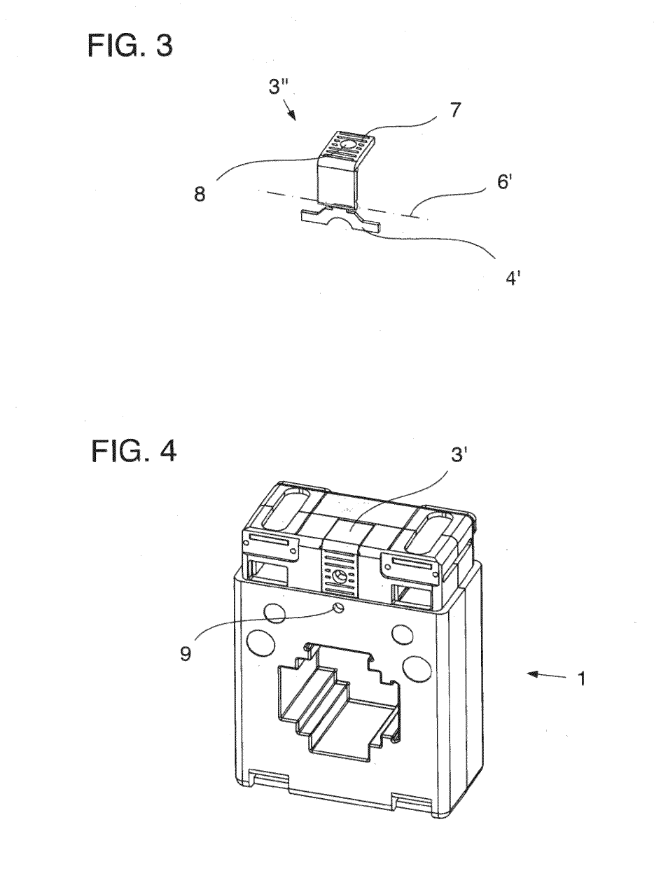

FIG. 3 shows essential elements of an associated first short-circuit device,

FIG. 4 shows a perspective illustration of a first embodiment of a current transformer according to the invention with open short-circuit device with complete housing,

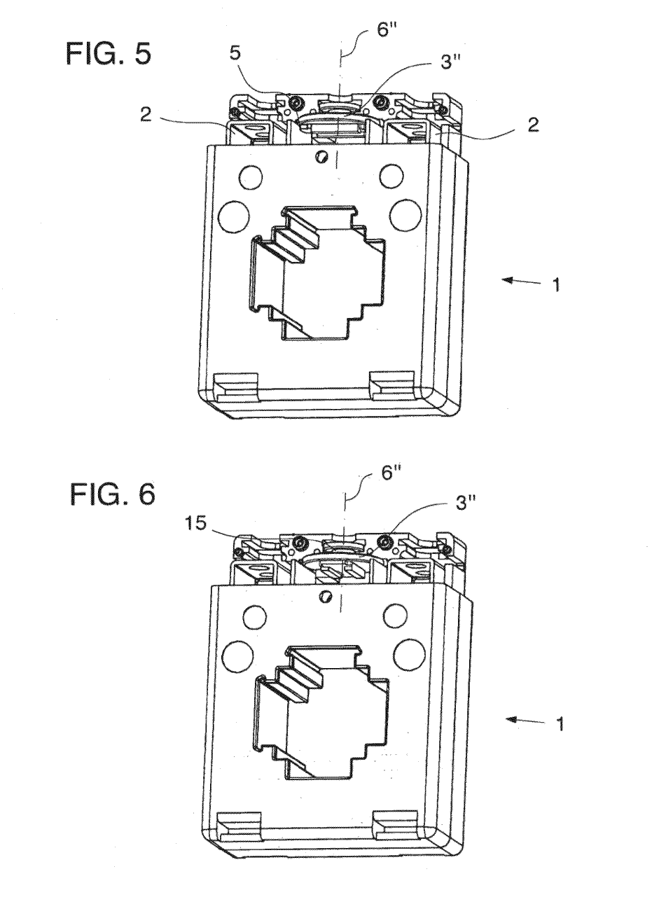

FIG. 5 shows a perspective illustration of a second embodiment of a current transformer according to the invention with shorted short-circuit device with open housing head,

FIG. 6 shows a perspective illustration of a second embodiment of a current transformer according to the invention with open short-circuit device with open housing head,

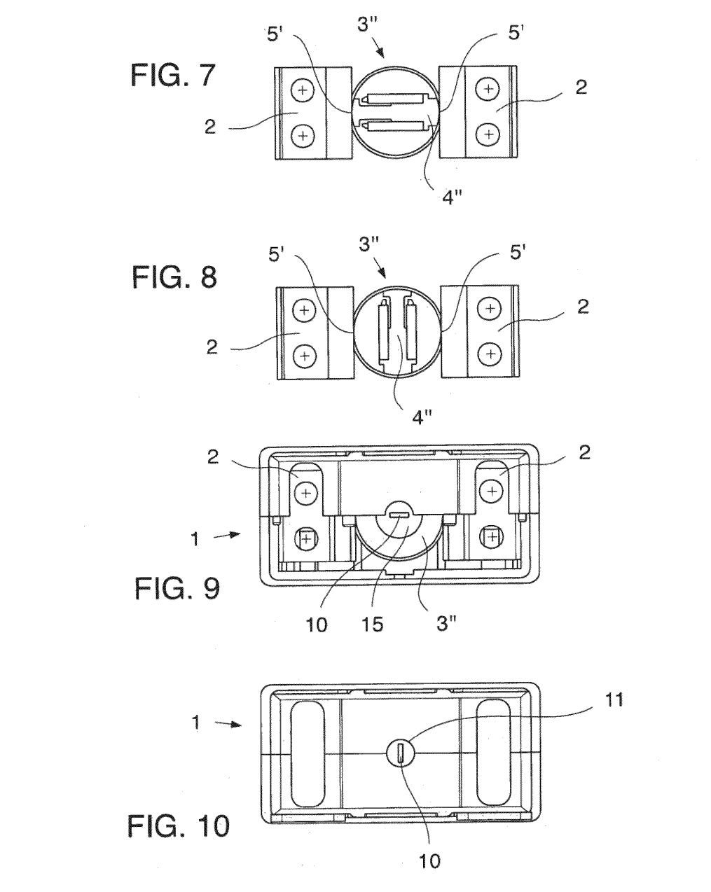

FIG. 7 shows an associated second short-circuit device in shorted position,

FIG. 8 shows the associated second short-circuit device in open position,

FIG. 9 shows a view from the end face of a second embodiment of a current transformer according to the invention with closed short-circuit device with partially open housing head,

FIG. 10 shows a view from the end face of a second embodiment of a current transformer according to the invention with open short-circuit device with complete housing,

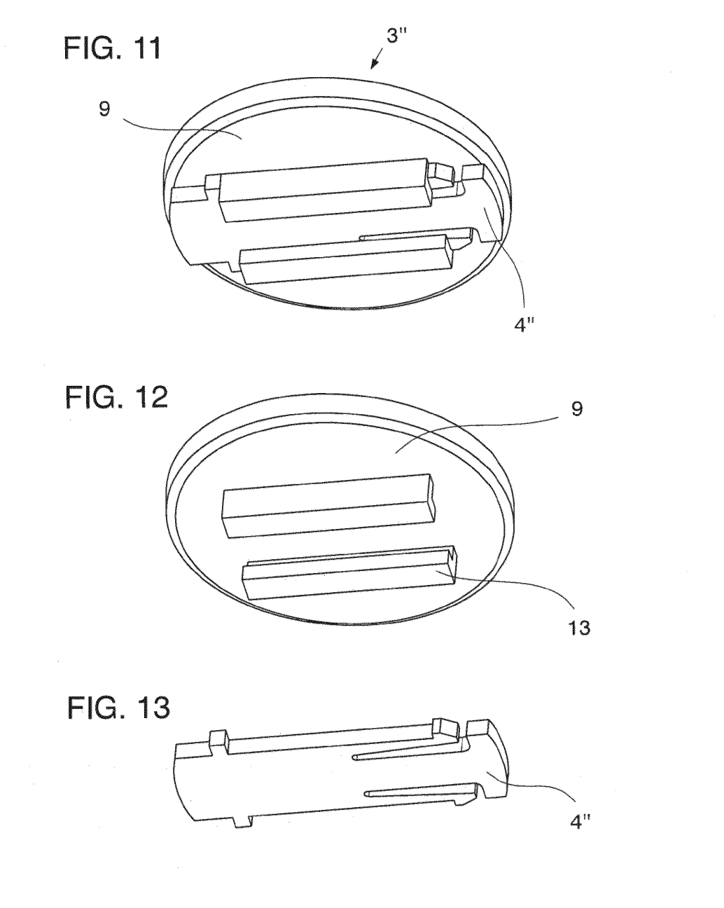

FIG. 11 shows a perspective view of essential elements of the associated second short-circuit device,

FIG. 12 shows a perspective view of an exemplary embodiment of an associated round plate, and

FIG. 13 shows a perspective view of an exemplary embodiment of a short-circuit piece for use with a round plate.

FIG. 1 shows a first embodiment of a current transformer according to the invention with short-circuit device 3′.

The illustration is perspective, the short-circuit device 3′ is located in a shorted position, and half of the housing head is removed to provide an improved view.

The lower part of the housing 14, which is square in projection, comprises a secondary winding with a ferromagnetic core. The central opening of the housing 14 is used to pass through a primary conductor, wherein the profile of the opening is suitable for receiving bus bars in conventional, standardised formats with an accurate fit.

The upper part of the housing 14 contains the connection contacts 2 of the current transformer 1 as housing head, the ends of the secondary winding (not shown here) being electrically connected to said connection contacts.

In the region of the connection contacts 2, the housing head has lateral and also end-face openings, wherein the lateral openings are used to supply connection conductors and the end-face openings are used for manipulation of the connection contacts 2.

The connection contacts 2 have a U-shaped profile in portions. Such a profile forms a leaf spring depending on the rigidity of the contact material and the dimensioning, such that this has a certain spring effect when pressure is exerted at a short-circuit contact 5.

The short-circuit device 3′ of the embodiment of the invention shown in FIG. 1 is closed. The lever arm of a short-circuit device 3′ rotatable about an axis of rotation 6′ protrudes from the housing 14 and a short-circuit piece 4′ is pressed onto the short-circuit contact 5. The circuit between the two connection contacts 2 of the secondary coil is thus closed.

FIG. 2 shows the same embodiment of a current transformer 1 according to the invention with open short-circuit device 3′. The actuation arm 7 of the short-circuit device 3′ is folded down and is received flush by a recess of the housing 14. The short-circuit piece 4′ is folded up and the circuit between the connection contacts 2 is interrupted at the short-circuit contacts 5.

FIG. 3 shows essential elements of a first short-circuit device 3′ for use in the first embodiment of the invention. Here, the short-circuit device 3′ has two angles in the cross section thereof. A first angle, above the axis of rotation 6′ in the illustration, constitutes an actuation arm 7. The angled embodiment thereof brings the advantage that it nestles against the shape of the housing in the position folded down or is received thereby, as can be seen in FIG. 4.

A second angle, below the axis of rotation 6′ in the illustration of FIG. 3, leads to a staggered arrangement of the surfaces of a short-circuit piece 4′ and those of the actuation arm 7, such that the folded-down actuation arm 7 terminates flush with the surface of the housing 14, the short-circuit piece 4′ however remains in the housing 14 beneath the surface thereof.

The actuation arm 7 has a bore or an eyelet 8, which for example is suitable in conjunction with a second eyelet for securing the short-circuit device 3′ using a wire seal.

FIG. 4 shows the first embodiment of a current transformer 1 according to the invention with open short-circuit device 3′ and complete housing 14, which receives the folded-down actuation arm 7 of the short-circuit device 3′ in a flush manner.

FIG. 5 shows a second embodiment of the invention. This is a perspective illustration, wherein only half the housing 14 in the head region is illustrated to provide an improved view of the short-circuit device 3′.

The coil former with the secondary coil hidden by the housing 14 corresponds to that of the first embodiment of the invention. The partially U-shaped connection contacts 2 also correspond to the first embodiment of the invention. By contrast, the axis of rotation and swivel axis 6″ runs orthogonally to the direct path between the contact points 5′. In the embodiment shown in FIG. 5 this corresponds to the longitudinal axis of the current transformer 1.

In the case of the current transformer 1 shown in FIG. 5 the short-circuit device 3″ is in the shorted position. The short-circuit piece 4″ contacts the short-circuit contacts 5′ of the connection contacts 2 on both sides and thus closes the circuit between the connection contacts 2.

FIG. 6 shows the current transformer 1 in the embodiment according to FIG. 5 with open short-circuit device 3″.

The short-circuit piece 4″ secured on a round plate 9 is twisted through 90° compared to FIG. 5 and the circuit between the connection contacts 2 is interrupted.

FIG. 6 also shows a rotary device 15, consisting of the round plate 9 and also a second, smaller plate. This is arranged at a distance from the round plate 9, said distance being filled by a web of the housing 14, such that the plate is held in position rotatably by the web in the axial direction. In addition, a form-fitting embodiment of the web in relation to the axis of the rotary device enables a radial mounting of the rotary device 15.

FIG. 7 shows the short-circuit device 3″ of the second embodiment of the current transformer 1 in shorted position. Here, the short-circuit piece 4″ closes the circuit between the connection contacts 2 via the short-circuit contacts 5′.

FIG. 8 shows the same short-circuit device 3″ in the open position, in which the short-circuit piece 4″ is rotated with respect to the position in FIG. 7, such that the circuit between the connection contacts 2 is interrupted.

FIG. 9 shows the end-face view of the second embodiment of the current transformer 1, in which half the head of the housing 14 is removed. The rotary device 15 of the short-circuit device 3″ is visible as well as a recess 10 located thereon.

FIG. 10 shows the end-face view of the second embodiment of the current transformer 1 with completely closed housing 14. A tool can be introduced into the housing 14 through an opening 11 and can engage with the recess 10. The short-circuit device 3″ can thus be closed and/or opened via a rotary motion by means of a tool, for example a screwdriver.

FIG. 11 shows an embodiment of the round plate 9 with a short-circuit piece 4″ secured thereon. The short-circuit piece 4″ is rounded at the ends thereof, such that it terminates flush with the edge of the round plate 9. As the short-circuit piece 4″ is rotated into the shorted position according to FIG. 7, there are thus no additional forces to be applied besides the frictional forces.

FIG. 12 shows the round plate 9 with two guide receptacles 13 for receiving a short-circuit piece 4″, wherein the guide receptacles 13 have such a profile that they fix the short-circuit piece 4″ to the round plate 9 in the directions along the axis of rotation 6″. This can be achieved for example by the embodiment of a dovetail profile or of the L-shaped profile shown here.

FIG. 13 shows a short-circuit piece 4″ that has two pairs of hooks, at least one of which is formed as resilient hooks 12, said hooks being distanced such that the length of the guide receptacle 13 of the round plate corresponds to the spacing of the hooks.

### LIST OF REFERENCE SIGNS

current transformer 1

connection contact 2

short-circuit device 3′, 3″

movable conductor 4

short-circuit piece 4′, 4″

short-circuit contact 5, 5′

axis of rotation or swivel axis 6′, 6″

actuation arm 7

eyelet 8

round plate 9

recess 10

opening 11

resilient hook 12

guide receptacle 13

housing 14

rotary device 15

1. A current transformer, having connection contacts for contacting a secondary winding and having a short-circuit device for shorting the connection contacts, wherein the short-circuit device has a mechanically movable conductor that can be brought into a circuit between the connection contacts of the secondary winding, wherein the short-circuit device is integrated in a housing surrounding the current transformer, the connection contacts each having or being electrically conductively connected to a short-circuit contact and the movable conductor can be moved by a rotary or pivot motion, whereat the axis of rotation or swivel axis runs along an axis through the short-circuit contacts or parallel thereto, into the circuit between the connection contacts, such that the circuit of the secondary coil is shorted.

2. The current transformer according to claim 1, wherein the movable conductor is formed as a short-circuit piece in the form of a rigid metal conductor.

3.-4. (canceled)

5. The current transformer according to claim 1, wherein the short-circuit device has an angled cross section and the axis of rotation or swivel axis runs through a the bend of the angle.

6. The current transformer according to claim 5, wherein a leg of the angle is formed as an actuation arm and the other leg has a short-circuit piece.

7. The current transformer according to claim 6, wherein the axis of rotation or swivel axis is arranged beneath or in the wall of the housing in such a way that the actuation arm terminates flush with the surface of the housing and/or the actuation arm is received by the housing of the current transformer.

8. The current transformer according to claim 6 wherein the actuation arm has an eyelet, such that it can be secured in cooperation with a second eyelet, which is arranged in or on the housing of the current transformer via a wire seal.

9. The current transformer according to claim 6 wherein the actuation arm of the short-circuit device protrudes visibly from the surface of the housing in a shorted state.

10.-12. (canceled)

13. The current transformer according to claim 7, wherein the actuation arm has an eyelet, such that it can be secured in cooperation with a second eyelet, which is arranged in or on the housing of the current transformer via a wire seal.

14. The current transformer according to claim 7, wherein the actuation arm of the short-circuit device protrudes visibly from the surface of the housing in a shorted state.

15. The current transformer according to claim 8, wherein the actuation arm of the short-circuit device protrudes visibly from the surface of the housing in a shorted state.

16. The current transformer according to claim 2, wherein the short-circuit device has an angled cross section and the axis of rotation or swivel axis runs through a bend of the angle.

17. The current transformer according to claim 16, wherein a leg of the angle is formed as an actuation arm and the other leg has a short-circuit piece.

18. The current transformer according to claim 17, wherein the axis of rotation or swivel axis is arranged beneath or in the wall of the housing in such a way that the actuation arm terminates flush with the surface of the housing and/or the actuation arm is received by the housing of the current transformer.

19. The current transformer according to claim 17, wherein the actuation arm has an eyelet, such that it can be secured in cooperation with a second eyelet, which is arranged in or on the housing of the current transformer via a wire seal.

20. The current transformer according to claim 17, wherein the actuation arm of the short-circuit device protrudes visibly from the surface of the housing in a shorted state.

21. The current transformer according to claim 18, wherein the actuation arm has an eyelet, such that it can be secured in cooperation with a second eyelet, which is arranged in or on the housing of the current transformer via a wire seal.

22. The current transformer according to claim 18, wherein the actuation arm of the short-circuit device protrudes visibly from the surface of the housing in a shorted state.

23. The current transformer according to claim 19, wherein the actuation arm of the short-circuit device protrudes visibly from the surface of the housing in a shorted state.
